(19) United States
(12) Patent Application Publication
(10) Pub. No.: US 2026/0044720 A1
(43) Pub. Date: Feb. 12, 2026

(54) NEURAL NETWORK TRAINING DEVICE AND NEURAL NETWORK TRAINING METHOD

(71) Applicant: Maxell, Ltd., Kyoto (JP)

(72) Inventor: Yuya SUGITA, Tokyo (JP)

(21) Appl. No.: 19/104,304

(22) PCT Filed: Jun. 5, 2023
(86) PCT No.: PCT/JP2023/020836

§ 371 Date: Aug. 26, 2025

(30) Foreign Application Priority Data
Aug. 19, 2022 (JP) 2022-131113

(51) Int. Cl. G06N 3/0495

(52) U.S. Cl. CPC G06N 3/0495

(57) ABSTRACT

A neural network training device is a device that trains a neural network performing an inference operation in a neural network circuit. The neural network training device includes a training unit configured to generate a trained parameter including a threshold value which is used in a quantization operation using a functional model of the neural network performing a convolutional operation and the quantization operation based on a floating decimal point format. The training unit generates the threshold value on the basis of a difference between an operation environment of the neural network circuit and an operation environment of the functional model.

### CROSS-REFERENCE TO RELATED APPLICATIONS

This application is the U.S. National Stage entry of International Application No. PCT/JP2023/020836, filed on Jun. 5, 2023, which, in turn, claims priority to JP Patent Application No. 2022-131113, filed on Aug. 19, 2022, both of which are hereby incorporated herein by reference in their entireties for all purposes.

### TECHNICAL FIELD

The present invention relates to a training device and a training method for a neural network circuit.

### BACKGROUND ART

Recently, a convolutional neural network (CNN) has been used as a model for image recognition or the like. A neural network circuit that can be assembled into an embedded device such as an loT device has been used (for example, see Patent Document 1).

On the other hand, known libraries or platforms have been used to determine a configuration or specifications of a convolutional neural network to generate a functional model of the convolutional neural network and to generate a trained parameter which has been trained using the functional model.

### CITATION LIST

### Patent Document

Patent Document 1: Japanese Patent No. 6896306

### SUMMARY OF INVENTION

### Technical Problem

When the functional model of a neural network or the trained parameter generated in these libraries or platforms is converted to an arithmetic operation that can be performed in the neural network circuit that can be assembled into an embedded device such as an IoT device and the arithmetic operation is performed, an error may occur in an operation result due to a difference in operation accuracy or data format.

In consideration of the aforementioned circumstances, an objective of the present invention is to provide a neural network training device and a neural network training method that can make it difficult for an error between an operation result based on a functional model and an operation result based on a neural network circuit to be caused when the functional model of a neural network and a trained parameter trained using the functional model are converted to an arithmetic operation that can be performed in the neural network circuit and the arithmetic operation is performed.

### Solution to Problem

In order to achieve the aforementioned objective, the present invention provides the following means.

According to a first aspect of the present invention, there is provided a neural network training device that trains a neural network performing an inference operation in a neural network circuit, the neural network training device including a training unit configured to generate a trained parameter including a threshold value which is used in a quantization operation using a functional model of the neural network performing a convolutional operation and the quantization operation based on a floating decimal point format, wherein the training unit generates the threshold value on the basis of a difference between an operation environment of the neural network circuit and an operation environment of the functional model.

According to a second aspect of the present invention, there is provided a neural network training method of training a neural network performing an inference operation in a neural network circuit, the neural network training method including a training step of generating a trained parameter including a threshold value which is used in a quantization operation using a functional model of the neural network performing a convolutional operation and the quantization operation based on a floating decimal point format, wherein the training step includes generating the threshold value on the basis of a difference between an operation environment of the neural network circuit and an operation environment of the functional model.

### Advantageous Effects of Invention

With the neural network training device and the neural network training method according to the present invention, it is possible to make it difficult to cause an error between an operation result based on a functional model and an operation result based on a neural network circuit when the functional model of a neural network and a trained parameter trained using the functional model are converted to an arithmetic operation that can be performed in the neural network circuit and the arithmetic operation is performed.

### BRIEF DESCRIPTION OF DRAWINGS

FIG. 1 A diagram illustrating a neural network training device according to a first embodiment.

FIG. 2 A diagram illustrating inputs and outputs of an arithmetic operation unit of the neural network training device.

FIG. 3 A diagram illustrating a convolutional neural network.

FIG. 4 A diagram illustrating a convolutional operation that is performed in a convolution layer.

FIG. 5 A diagram illustrating division and development of data in the convolutional operation.

FIG. 6 A diagram illustrating the entire configuration of a neural network circuit according to the first embodiment.

FIG. 7 A timing chart illustrating an example of operations of the neural network circuit.

FIG. 8 An internal block diagram of a DMAC of the neural network circuit.

FIG. 9 A state transition diagram of a control circuit of the DMAC.

FIG. 10 An internal block diagram of a convolutional operation circuit of the neural network circuit.

FIG. 11 An internal block diagram of a multiplier of the convolutional operation circuit.

FIG. 12 An internal block diagram of a product-sum operation unit of the multiplier.

FIG. 13 An internal block diagram of an accumulator circuit of the convolutional operation circuit.

FIG. 14 An internal block diagram of an accumulator unit of the accumulator circuit.

FIG. 15 An internal block diagram of a quantization operation circuit of the neural network circuit.

FIG. 16 An internal block diagram of a vector operation circuit and a quantization circuit of the quantization operation circuit.

FIG. 17 A block diagram of an arithmetic operation unit.

FIG. 18 An internal block diagram of a vector quantization unit of the quantization circuit.

FIG. 19 A control flowchart of the neural network training device.

FIG. 20 A diagram illustrating an example of a GUI image for setting the convolutional neural network.

FIG. 21 A diagram illustrating an inference operation block in the neural network circuit.

FIG. 22 A diagram illustrating a quantization/convolutional operation block in the convolutional neural network.

FIG. 23 A flowchart illustrating a training process in the control flowchart.

FIG. 24 A diagram illustrating a forbidden band of a quantization parameter.

FIG. 25 A timing chart illustrating an allocation example in the neural network circuit.

### DESCRIPTION OF EMBODIMENTS

### First Embodiment

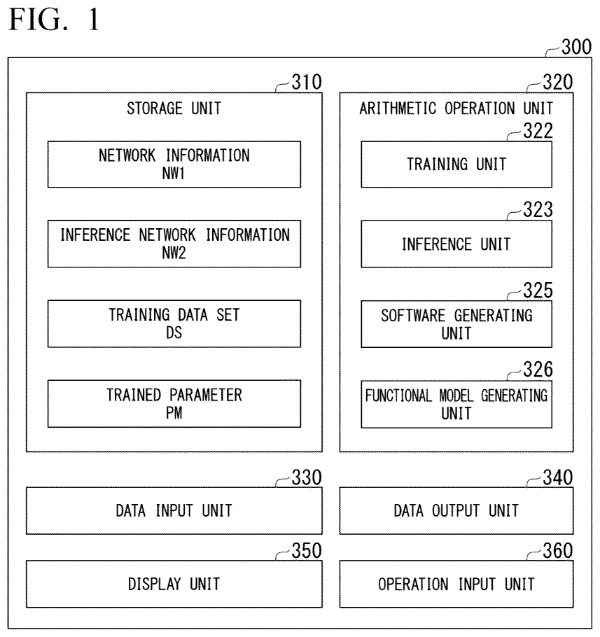

A first embodiment of the present invention will be described below with reference to FIGS. 1 to 25.

FIG. 1 is a diagram illustrating a neural network training device 300 according to a first embodiment.

### [Neural Network Training Device 300]

The neural network training device 300 is a device that performs generation and training of a convolutional neural network 200 (hereinafter also referred to as a “CNN 200” or an “NN functional model 200”) which is a neural network functional model and generation of software 500 for activating a neural network circuit 100 (hereinafter also referred to as an “NN circuit 100”) that is able to be assembled into an embedded device such as an IoT device. Operations performed by the NN circuit 100 are at least a part of an inference operation that is performed by the CNN 200 (the NN functional model 200).

The neural network training device 300 is a program-executable device (a computer) including hardware such as a processor such as a central processing unit (CPU) and a memory. The functions of the neural network training device 300 are realized by executing a neural network training program and a software generation program in the neural network training device 300. The neural network training device 300 includes a storage unit 310, an arithmetic operation unit 320, a data input unit 330, a data output unit 340, a display unit 350, and an operation input unit 360.

The storage unit 310 stores network information NW1, inference network information NW2, a training data set DS, and a trained parameter PM. The training data set DS and the inference network information NW2 are input data that is input to the neural network training device 300. The trained parameter PM is output data that is output from the neural network training device 300. A “trained NN circuit 100” includes the NN circuit 100 and the trained parameter PM.

The network information (training network information) NW1 is information on the CNN 200 (the NN functional model 200). The network information NW1 includes, for example, information for defining the functions of the CNN 200 (the NN functional model 200). The network information NW1 includes, for example, a network structure, input data information, output data information, and quantization information of the CNN 200. The input data information includes an input data type such as an image or sound and an input data size.

The inference network information NW2 is information on an inference operation that is performed by the NN circuit 100. The inference network information NW2 includes, for example, information for defining the functions of the inference operation of a neural network that can be performed by the NN circuit 100. The inference network information NW2 includes, for example, a circuit structure of the NN circuit 100, a function of an arithmetic operator, and a data bit width.

The training data set DS includes training data D1 that is used for training and test data D2 that is used for an inference test.

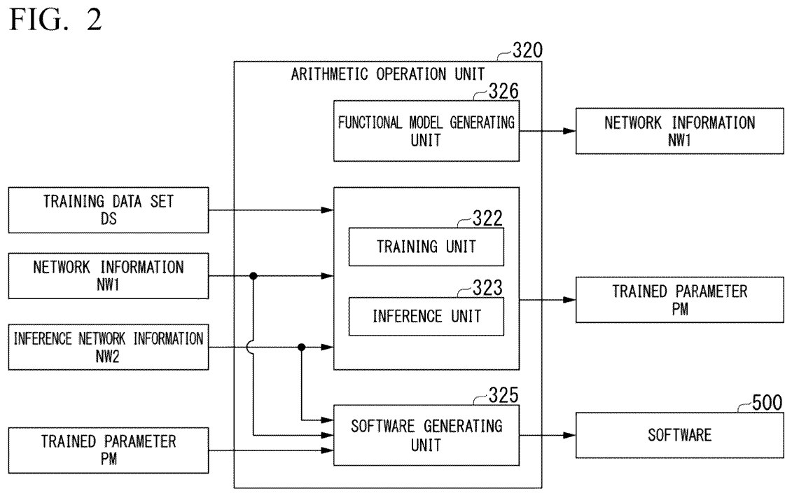

FIG. 2 is a diagram illustrating inputs/outputs of the arithmetic operation unit 320.

The arithmetic operation unit 320 includes a training unit 322, an inference unit 323, a software generating unit 325, and a functional model generating unit 326. The network information NW input to the arithmetic operation unit 320 may be generated by a device other than the neural network training device 300.

The training unit 322 generates a trained parameter PM using the network information NW1, the inference network information NW2, and the training data D1. The inference unit 323 performs an inference test using the network information NW and the test data D2.

The software generating unit 325 generates software 500 for activating the NN circuit 100 on the basis of the network information NW1 and the inference network information NW2. The software 500 includes software for transferring the trained parameter PM to the NN circuit 100 according to necessity.

The functional model generating unit 326 generates a CNN 200 (an NN functional model 200) on the basis of an input from a user (configuration) and outputs network information NW1 which is information on the CNN 200 (the NN functional model 200).

Hardware information HW, network information NW, and the like required for generating a trained NN circuit 100 are input to the data input unit 330. The hardware information HW, the network information NW, and the like are input, for example, as data described in a predetermined data format. The input hardware information HW, the input network information NW, and the like are stored in the storage unit 310. The hardware information HW, the network information NW, and the like may be input or changed by a user via the operation input unit 360.

The generated trained NN circuit 100 is output to the data output unit 340. For example, the generated NN circuit 100 and the trained parameter PM are output to the data output unit 340.

The display unit 350 includes a known monitor such as an LCD display. The display unit 350 can display a graphical user interface (GUI) image generated by the arithmetic operation unit 320, a console screen for receiving a command, or the like. When the arithmetic operation unit 320 needs an input of information from a user, the display unit 350 can display a message for prompting a user to input information via the operation input unit 360 or a GUI image required for inputting information.

The operation input unit 360 is a device that is used for a user to input an instruction to the arithmetic operation unit 320 or the like. The operation input unit 360 is a known input device such as a touch panel, a keyboard, or a mouse. The input to the operation input unit 360 is transmitted to the arithmetic operation unit 320.

All or some of the functions of the arithmetic operation unit 320 are realized, for example, by causing one or more processors such as a central processing unit (CPU) or a graphics processing unit (GPU) to execute a program stored in a program memory. Here, all or some of the functions of the arithmetic operation unit 320 may be realized by hardware (for example, a circuit unit: circuitry) such as a large scale integration (LSI) circuit, an application-specific integrated circuit (ASIC), a field-programmable gate array (FPGA), or a programmable logic device (PLD). All or some of the functions of the arithmetic operation unit 320 may be cooperatively realized by software and hardware.

All or some of the functions of the arithmetic operation unit 320 may be realized using an external accelerator such as a CPU, a GPU, or hardware provided in an external device such as a cloud server. The arithmetic operation unit 320, for example, can use a GPU or dedicated hardware with high computational performance on the cloud server together to improve a computing speed of the arithmetic operation unit 320.

The storage unit 310 is realized using a flash memory, an electrically erasable programmable read-only memory (EEPROM), a read-only memory (ROM), or a random access memory (RAM), or the like. All or a part of the storage unit 310 may be provided in an external device such as a cloud server and be connected to the arithmetic operation unit 320 or the like via a communication line.

The neural network training device 300 may include a plurality of devices (computers), and the functional blocks of the arithmetic operation unit 320 may be distributed to the plurality of devices. For example, the neural network training device 300 may be divided into a first device (a computer) including the functional model generating unit 326, a second device (a computer) including the training unit 322 and the inference unit 323, and a third device (a computer) including the software generating unit 325.

### [Convolutional Neural Network (CNN) 200]

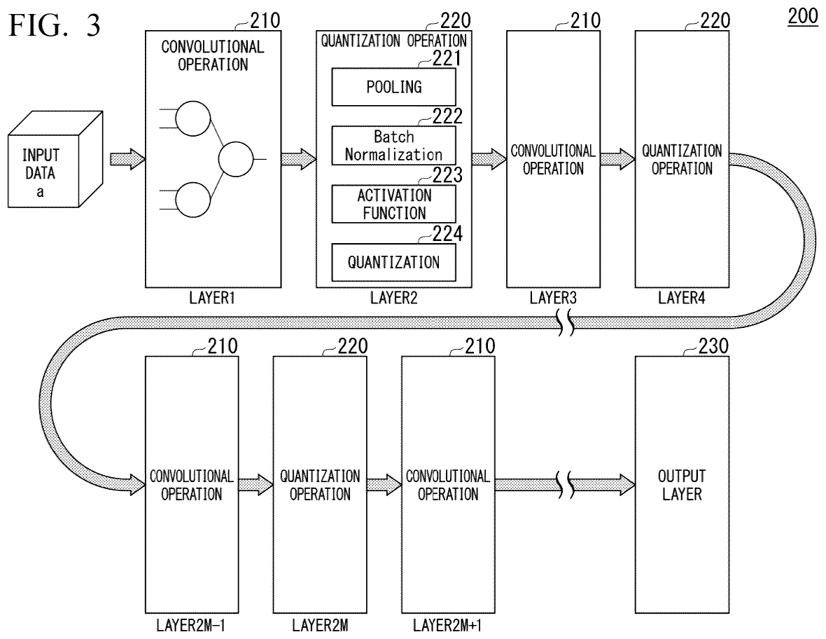

FIG. 3 is a diagram illustrating the CNN 200.

The CNN 200 is a network with a multi-layered structure including a convolution layer 210 that performs a convolutional operation, a quantization operation layer 220 that performs a quantization operation, and an output layer 230. In at least a part of the CNN 200, the convolution layer 210 and the quantization operation layer 220 are alternately connected. The CNN 200 is a model which is widely used for image recognition or video recognition. The CNN 200 may further include a layer having another function such as a totally coupled layer.

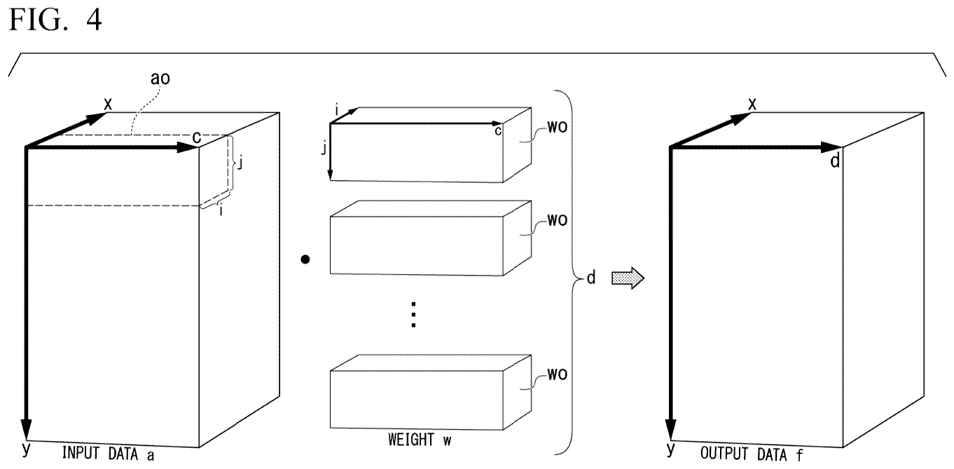

FIG. 4 is a diagram illustrating a convolutional operation that is performed by the convolution layer 210.

The convolution layer 210 performs a convolutional operation using a weight w on input data a. The convolution layer 210 performs a product-sum operation with the input data a and the weight w as inputs.

The input data a (also referred to as activation data or a feature map) to the convolution layer 210 is multi-dimensional data such as image data. In the present embodiment, the input data a is a three-dimensional tensor including elements (x, y, c). The convolution layer 210 of the CNN 200 performs a convolutional operation on the input data a of fewer bits. In the present embodiment, the elements of the input data a are unsigned integers of 2 bits (0, 1, 2, 3). The elements of the input data a may be, for example, unsigned integers of 4 bits or 8 bits.

When input data input to the CNN 200 has a format such as a floating decimal point type of 32 bits different from that of the input data a to the convolution layer 210, the CNN 200 may further include an input layer for performing format conversion or quantization before the convolution layer 210.

A weight w (also referred to as a filter or a kernel) of the convolution layer 210 is multi-dimensional data including elements which are trainable parameters. In the present embodiment, the weight w is a four-dimensional tensor including elements (i, j, c, d). The weight w includes d three-dimensional tensors (hereinafter referred to as “weight wo”) including elements (i, j, c). The weight w in the trained CNN 200 is learned data. The convolution layer 210 of the CNN 200 performs a convolutional operation using the weight w of fewer bits. In the present embodiment, the elements of the weight w are signed integers (0, 1) of 1 bit, wherein the value “0” indicates+1 and the value “1” indicates −1.

The convolution layer 210 performs the convolutional operation expressed by Expression 1 and outputs output data f. In Expression 1, s denotes a stride. An area indicated by a dotted line in FIG. 4 is one of areas ao in which the weight wo is applied to the input data a (hereinafter referred to as “applied areas ao”). Elements of an applied area ao are expressed as (x+i, y+j, c).

$$\begin{matrix}[ Math . 1 ] & \\ f ( x , y , d ) = {\sum }_{i}^{κ} {\sum }_{j}^{κ} {\sum }_{c}^{C} a ( s \cdot x + i , s \cdot y + j , c ) \cdot w ( i , j , c , d ) & ( Expression 1 )\end{matrix}$$

The quantization operation layer 220 performs quantization or the like on the output of the convolutional operation output from the convolution layer 210. The quantization operation layer 220 includes a pooling layer 221, a batch normalization layer 222, an activation function layer 223, and a quantization layer 224.

The pooling layer 221 compresses output data f of the convolution layer 210 by performing an arithmetic operation such as average pooling (Expression 2) or MAX pooling (Expression 3) on the output data f of the convolutional operation output from the convolution layer 210. In Expression 2 and Expression 3, u denotes an input tensor, v denotes an output tensor, and T denotes a size of a pooling area. In Expression 3, max is a function of outputting a maximum value of u in correspondence with a combination of i and j included in T.

$$\begin{matrix}[ Math . 2 ] & \\ v ( x , y , c ) = \frac{1}{{T}^{2}} {\sum }_{i}^{T} {\sum }_{j}^{T} u ( T \cdot x + i , T \cdot y + j , c ) & ( Expression 2 )\end{matrix}$$

$$\begin{matrix}[ Math . 3 ] & \\ v ( x , y , c ) = max ( u ( T \cdot x + i , T \cdot y + j , c ) ) , i ∈ T , j ∈ T & ( Expression 3 )\end{matrix}$$

The batch normalization layer 222 normalizes a data distribution on output data of the quantization operation layer 220 or the pooling layer 221, for example, using an arithmetic operation expressed by Expression 4. In Expression 4, u denotes an input tensor, v denotes an output tensor, α denotes a scale, and β denotes a bias. In the trained CNN 200, α and β are learned constant vectors.

$$\begin{matrix}[ Math . 4 ] & \\ v ( x , y , c ) = α ( c ) \cdot ( u ( x , y , c ) - β ( c ) ) & ( Expression 4 )\end{matrix}$$

The activation function layer 223 calculates an activation function such as ReLU (Expression 5) on an output of the quantization operation layer 220, the pooling layer 221, or the batch normalization layer 222. In Expression 5, u denotes an input tensor, and v denotes an output tensor. In Expression 5, max is a function of outputting the largest numerical value of factors.

$$\begin{matrix}[ Math . 5 ] & \\ v ( x , y , c ) = max ( 0 , u ( x , y , c ) ) & ( Expression 5 )\end{matrix}$$

The quantization layer 224 performs, for example, quantization expressed by Expression 6 on the output of the pooling layer 221 or the activation function layer 223 on the basis of a quantization parameter. In the quantization expressed by Expression 6, the bits of the input tensor u are reduced by 2 bits. In Expression 6, q(c) is a vector of a quantization parameter. In the trained CNN 200, q(c) is a trained constant vector. Inequality “≤” in Expression 6 may be replaced with “≤.”

$$\begin{matrix}[ Math . 6 ] & \\ \begin{matrix}qtz ( x , y , c ) = 0 if u ( x , y , c ) ≦ q ( c ) . th 0 else \\ 1 if u ( x , y , c ) ≦ q ( c ) . th 1 else \\ 2 if u ( x , y , c ) ≦ q ( c ) . th 2 else \\ 3\end{matrix} & ( Expression 6 )\end{matrix}$$

The output layer 230 is a layer that outputs a result of the CNN 200 using an identity function, a Softmax function, or the like. A layer prior to the output layer 230 may be the convolution layer 210 or the quantization operation layer 220.

In the CNN 200, since the quantized output data of the quantization layer 224 is input to the convolution layer 210, a load of the convolutional operation of the convolution layer 210 is smaller than that in another convolutional neural network in which quantization is not performed.

### [Division of Convolutional Operation]

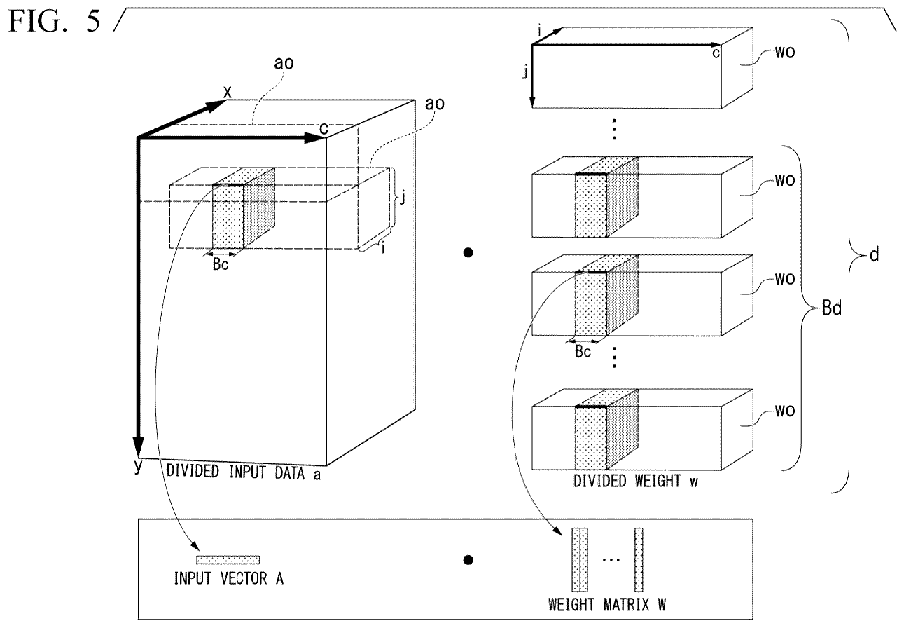

FIG. 5 is a diagram illustrating division and development of data in a convolutional operation.

The NN circuit 100 divides input data of the convolutional operation (Expression 1) of the convolution layer 210 into partial tensors and performs the arithmetic operation. The method of division or the number of divisions into the partial tensors is not particularly limited. The partial tensors are formed, for example, by dividing input data a(x+i, y+j, c) into a(x+i, y+j, co). The NN circuit 100 may perform an arithmetic operation on the input data of the convolutional operation (Expression 1) of the convolution layer 210 without dividing the input data.

In division of input data in the convolutional operation, the variable c in Expression 1 is divided into blocks with a size Bc as expressed by Expression 7. The variable d in Expression 1 is divided into blocks with a size Bd as expressed by Expression 8. In Expression 7, co is an offset, and ci is an index of from 0 to (Bc−1). In Expression 8, do is an offset, and di is an index of from 0 to (Bd−1). The size Bc and the size Bd may be the same.

$$\begin{matrix}[ Math . 7 ] & \\ c = co \cdot Bc + ci & ( Expression 7 )\end{matrix}$$

$$\begin{matrix}[ Math . 8 ] & \\ d = do \cdot Bd + d i & ( Expression 8 )\end{matrix}$$

The input data a(x+i, y+j, c) in Expression 1 is divided according to the size Bc in the c-axis direction and is expressed as divided input data a(x+i, y+j, co). In the following description, the divided input data a is also referred to as “division input data a.”

The weight w(i, j, c, d) is divided by the size Bc in the c-axis direction and the size Bd in the d-axis direction and is expressed by a divided weight w(i, j, co, do). In the following description, the divided weight w is also referred to as a “division weight w.”

Output data f(x, y, do) divided by the size Bd is calculated by Expression 9. Final output data f(x, y, d) can be calculated by combining the divided output data f(x, y, do)

$$\begin{matrix}[ Math . 9 ] & \\ f ( x , y , do ) = {\sum }_{i}^{κ} {\sum }_{j}^{κ} {\sum }_{co}^{C / Bc} a ( s \cdot x + i , s \cdot y + j , co ) \cdot w ( i , j , co , do ) & ( Expression 9 )\end{matrix}$$

### (Expression 9)

### [Development of Data in Convolutional Operation]

The NN circuit 100 develops the input data a and the weight w in the convolutional operation in the convolution layer 210 and performs a convolutional operation.

The division input data a(x+i, y+j, co) is developed in vector data including Bc elements. The elements of the division input data a are indexed by ci (0≤ci<Bc). In the following description, the division input data a developed in vector data for each of i and j is also referred to as an “input vector A.” The input vector A includes division input data a(x+i, y+j, co×Bc) to division input data a(x+i, y+j, co×Bc+ (Bc−1)) as elements.

The division weight w(i, j, co, do) is developed in matrix data including BcxBd elements. The elements of the division weight w developed in matrix data are indexed by ci and di(0≤di<Bd). In the following description, the division weight w developed in matrix data for each of i and j is also referred to as a “weight matrix W.” The weight matrix W includes a division weight w(i, j, co×Bc, do×Bd) to a division weight w(i, j, co×Bc+(Bc−1), do×Bd+(Bd−1)) as elements.

Vector data is calculated by multiplying the input vector A by the weight matrix W. The output data f(x, y, do) can be acquired by shaping the vector data calculated for each of i, j, and co in a three-dimensional tensor. By performing this development of data, the convolutional operation of the convolution layer 210 can be performed through multiplication of the vector data by the matrix data.

### [Neural Network Circuit (NN Circuit) 100]

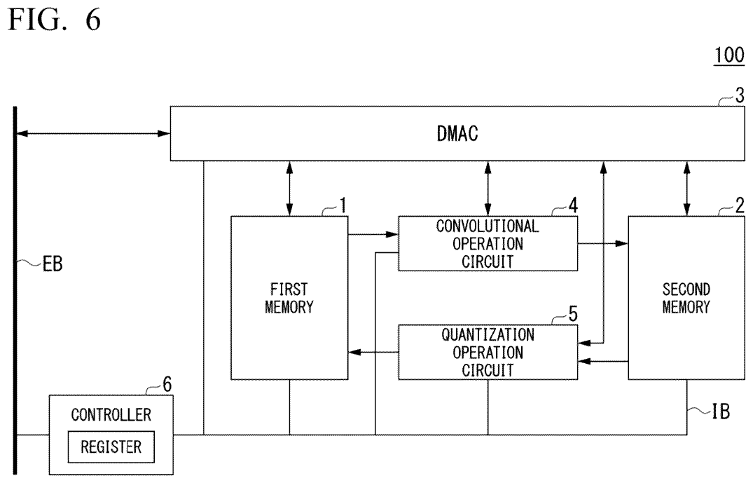

FIG. 6 is a diagram illustrating the entire configuration of the NN circuit 100 according to the present embodiment.

The NN circuit 100 includes a first memory 1, a second memory 2, a DMA controller 3 (hereinafter also referred to as a “DMAC 3”), a convolutional operation circuit 4, a quantization operation circuit 5, and a controller 6. The NN circuit 100 is characterized in that the convolutional operation circuit 4 and the quantization operation circuit 5 are formed in a loop shape via the first memory 1 and the second memory 2.

The first memory 1 is, for example, a rewritable memory such as a volatile memory constituted by a static RAM (SRAM). Writing and reading of data with respect to the first memory 1 are performed via the DMAC 3 or the controller 6. The first memory 1 is connected to an input port of the convolutional operation circuit 4, and the convolutional operation circuit 4 can read data from the first memory 1. The first memory 1 is connected to an output port of the quantization operation circuit 5, and the quantization operation circuit 5 can write data to the first memory 1. An external host CPU can input and output data with respect to the NN circuit 100 by writing and reading data with respect to the first memory 1.

The second memory 2 is, for example, a rewritable memory such as a volatile memory constituted by a static RAM (SRAM). Writing and reading of data with respect to the second memory 2 are performed via the DMAC 3 or the controller 6. The second memory 2 is connected to an input port of the quantization operation circuit 5, and the quantization operation circuit 5 can read data from the second memory 2. The second memory 2 is connected to an output port of the convolutional operation circuit 4, and the convolutional operation circuit 4 can write data to the second memory 2. The external host CPU can input and output data with respect to the NN circuit 100 by writing and reading data with respect to the second memory 2.

The DMAC 3 is connected to an external bus EB and performs data transfer between an external memory such as a DRAM and the first memory 1. The DMAC 3 performs data transfer between the external memory such as a DRAM and the second memory 2. The DMAC 3 performs data transfer between the external memory such as a DRAM and the convolutional operation circuit 4. The DMAC 3 performs data transfer between the external memory such as a DRAM and the quantization operation circuit 5.

The convolutional operation circuit 4 is a circuit that performs a convolutional operation in the convolution layer 210 of the trained CNN 200. The convolutional operation circuit 4 reads input data a stored in the first memory 1 and performs a convolutional operation on the input data a. The convolutional operation circuit 4 writes output data f of the convolutional operation (hereinafter also referred to as “convolutional operation output data”) to the second memory 2.

The quantization operation circuit 5 is a circuit that performs at least a part of the quantization operation in the quantization operation layer 220 of the trained CNN 200. The quantization operation circuit 5 reads output data f of the convolutional operation stored in the second memory 2 and performs a quantization operation (an arithmetic operation including at least quantization of pooling, batch normalization, an activation function, and quantization) on the output data f of the convolutional operation. The quantization operation circuit 5 writes output data of the quantization operation (hereinafter also referred to as “quantization operation output data”) to the first memory 1.

The controller 6 is connected to the external bus EB and operates as a slave of the external host CPU. The controller 6 includes a resister 61 including a parameter register or a state register. The parameter register is a register controlling the operation of the NN circuit 100. The state register is a register indicating the state of the NN circuit 100 including a semaphore S. The external host CPU can access the register 61 via the controller 6.

The controller 6 is connected to the first memory 1, the second memory 2, the DMAC 3, the convolutional operation circuit 4, and the quantization operation circuit 5 via an internal bus IB. The external host CPU can access each block via the controller 6. For example, the external host CPU can give an instruction to the DMAC 3, the convolutional operation circuit 4, or the quantization operation circuit 5 via the controller 6. The DMAC 3, the convolutional operation circuit 4, or the quantization operation circuit 5 can update the state register (which includes the semaphore S) included in the controller 6 via the internal bus IB. The state register (which includes the semaphore S) may be configured to be updated via a dedicated line connected to the DMAC 3, the convolutional operation circuit 4, or the quantization operation circuit 5.

The NN circuit 100 includes the first memory 1 and the second memory 2 and can thus decrease the number of times of repeated data transfer in transfer of data from the external memory such as a DRAM by the DMAC 3. Accordingly, it is possible to greatly decrease power consumption which is generated in access to a memory.

### Operation Example 1 of NN Circuit 100

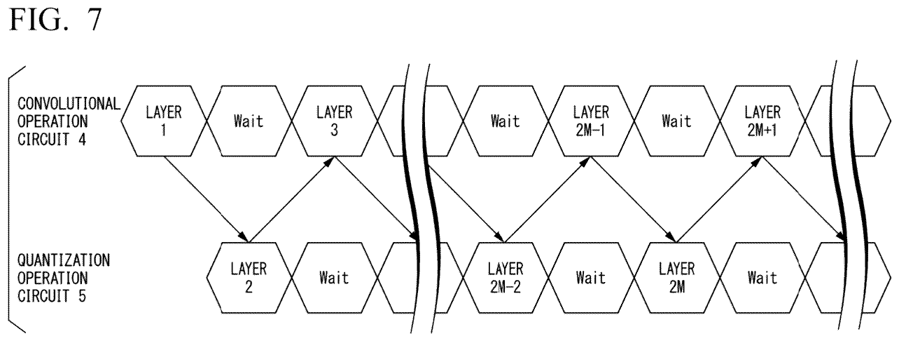

FIG. 7 is a timing chart illustrating an example of operations of the NN circuit 100.

The DMAC 3 stores input data a of Layer 1 in the first memory 1. The DMAC 3 may divide the input data a of Layer 1 and transfer the divided input data to the first memory 1 in the order of the convolutional operation that is performed by the convolutional operation circuit 4.

The convolutional operation circuit 4 reads the input data a of Layer 1 stored in the first memory 1. The convolutional operation circuit 4 performs a convolutional operation of Layer 1 illustrated in FIG. 3 on the input data a of Layer 1. Output data f of the convolutional operation of Layer 1 is stored in the second memory 2.

The quantization operation circuit 5 reads the output data f of Layer 1 stored in the second memory 2. The quantization operation circuit 5 performs a quantization operation of Layer 2 on the output data f of Layer 1. The output data of the quantization operation of Layer 2 is stored in the first memory 1.

The convolutional operation circuit 4 reads the output data of the quantization operation of Layer 2 stored in the first memory 1. The convolutional operation circuit 4 performs a convolutional operation of Layer 3 using the output data of the quantization operation of Layer 2 as input data a. The output data f of the convolutional operation of Layer 3 is stored in the second memory 2.

The convolutional operation circuit 4 reads the output data of the quantization operation of Layer 2M−2 (where M is a natural number) stored in the first memory 1. The convolutional operation circuit 4 performs a convolutional operation of Layer 2M−1 using the output data of the quantization operation of Layer 2M−2 as input data a. The output data f of the convolutional operation of Layer 2M−1 is stored in the second memory 2.

The quantization operation circuit 5 reads the output data f of Layer 2M−1 stored in the second memory 2. The quantization operation circuit 5 performs a quantization operation of Layer 2M on the output data f of Layer 2M−1. The output data of the quantization operation of Layer 2M is stored in the first memory 1.

The convolutional operation circuit 4 reads the output data of the quantization operation of Layer 2M stored in the first memory 1. The convolutional operation circuit 4 performs a convolutional operation of Layer 2M+1 using the output data of the quantization operation of Layer 2M as input data a. The output data f of the convolutional operation of Layer 2M+1 is stored in the second memory 2.

The convolutional operation circuit 4 and the quantization operation circuit 5 alternately perform operations to cause the operations of the CNN 200 illustrated in FIG. 3 to progress. The convolutional operation circuit 4 of the NN circuit 100 performs the convolutional operation of Layer 2M−1 and Layer 2M+1 in a time division manner. The quantization operation circuit 5 of the NN circuit 100 performs the quantization operation of Layer 2M−2 and Layer 2M in a time division manner. Accordingly, a circuit scale of the NN circuit 100 is much smaller than that in a case in which the convolutional operation circuit 4 and the quantization operation circuit 5 which are different for each layer are mounted.

The NN circuit 100 performs an arithmetic operation of the CNN 200 with a multi-layered structure including a plurality of layers using a circuit formed in a loop shape. The NN circuit 100 can efficiently use hardware resources with this circuit configuration of a loop shape. In the NN circuit 100, parameters of the convolutional operation circuit 4 or the quantization operation circuit 5 varying depending on the layers are appropriately updated to form the circuit in a loop shape.

When the arithmetic operations of the CNN 200 include an arithmetic operation which cannot be performed by the NN circuit 100, the NN circuit 100 transfers intermediate data to an external operation device such as the external host CPU. The external operation device performs an arithmetic operation on the intermediate data, and the operation result from the external operation device is input to the first memory 1 or the second memory 2. The NN circuit 100 restarts an arithmetic operation on the operation result from the external operation device.

The configuration of each constituent of the NN circuit 100 will be described below in detail.

### [DMAC 3]

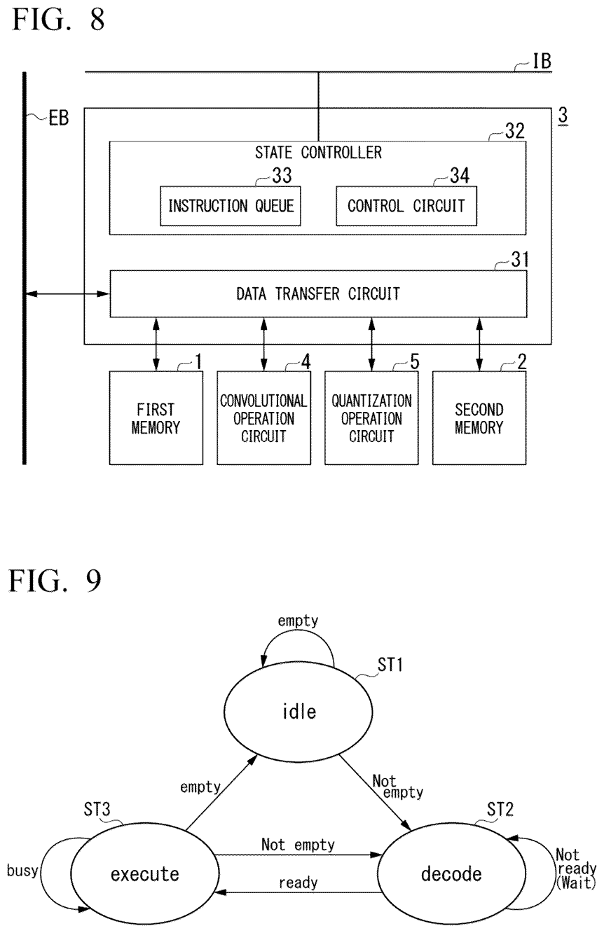

FIG. 8 is an internal block diagram of the DMAC 3.

The DMAC 3 includes a data transfer circuit 31 and a state controller 32. The DMAC 3 includes the state controller 32 dedicated for the data transfer circuit 31 and can transfer DMA data without requiring an external controller when an instruction command is input thereto.

The data transfer circuit 31 is connected to the external bus EB and transfers DMA data between the external memory of a DRAM and the first memory 1. The data transfer circuit 31 transfers DMA data between the external memory of a DRAM and the second memory 2. The data transfer circuit 31 transfers DMA data between the external memory of a DRAM and the convolutional operation circuit 4. The data transfer circuit 31 transfers DMA data between the external memory of a DRAM and the quantization operation circuit 5. The number of DMA channels of the data transfer circuit 31 is not limited. For example, each of the first memory 1 and the second memory 2 may include a dedicated DMA channel.

The state controller 32 controls the state of the data transfer circuit 31. The state controller 32 is connected to the controller 6 via the internal bus IB. The state controller 32 includes an instruction queue 33 and a control circuit 34.

The instruction queue 33 is a queue in which an instruction command C3 for the DMAC 3 is stored and is constituted, for example, by a FIFO memory. One or more instruction commands C3 are written to the instruction queue 33 via the internal bus IB.

The control circuit 34 is a state machine that decodes the instruction command C3 and sequentially controls the data transfer circuit 31 on the basis of the instruction command C3. The control circuit 34 may be mounted as a logic circuit or may be mounted as a CPU that is controlled by software.

FIG. 9 is a state transition diagram of the control circuit 34.

When the instruction command C3 is input to the instruction queue 33 (not empty), the control circuit 34 transitions from an idle state ST1 to a decode state ST2.

In the decode state ST2, the control circuit 34 decodes the instruction command C3 output from the instruction queue 33. The control circuit 34 reads a semaphore S stored in the register 61 of the controller 6 and determines whether the operation of the data transfer circuit 31 indicated by the instruction command C3 is executable. When the operation is not executable (not ready), the control circuit 34 waits until the operation becomes executable (wait). When the operation is executable (ready), the control circuit 34 transitions from the decode state ST2 to an execute state ST3.

The control circuit 34 controls the data transfer circuit 31 in the execute state ST3 such that the data transfer circuit 31 performs the operation indicated by the instruction command C3. When the operation of the data transfer circuit 31 ends, the control circuit 34 deletes the executed instruction command C3 from the instruction queue 33 and updates the semaphore S stored in the register 61 of the controller 6. When an instruction is left in the instruction queue 33 (not empty), the control circuit 34 transitions from the execute state ST3 to the decode state ST2. When no instruction is left in the instruction queue 33 (empty), the control circuit 34 transitions from the execute state ST3 to the idle state ST1.

### [Convolutional Operation Circuit 4]

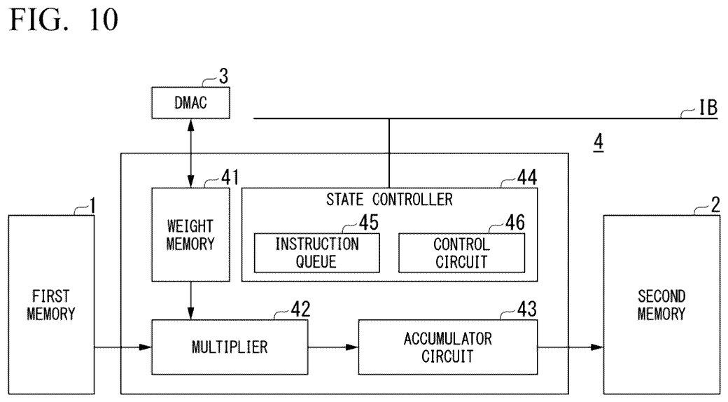

FIG. 10 is an internal block diagram of the convolutional operation circuit 4.

The convolutional operation circuit 4 includes a weight memory 41, a multiplier 42, an accumulator circuit 43, and a state controller 44. The convolutional operation circuit 4 includes the state controller 44 dedicated for the multiplier 42 and the accumulator circuit 43 and can perform a convolutional operation without requiring an external controller when an instruction command is input thereto.

The weight memory 41 is a memory in which the weights w used for the convolutional operation are stored and is, for example, a rewritable memory such as a volatile memory constituted by a static RAM (SRAM). The DMAC 3 writes a weight w required for the convolutional operation to the weight memory 41 through DMA transfer.

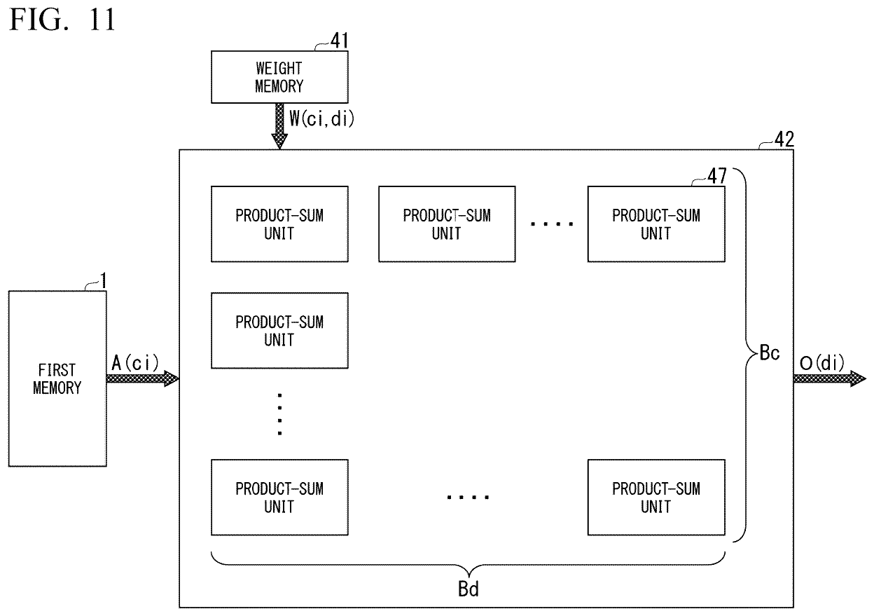

FIG. 11 is an internal block diagram of the multiplier 42.

The multiplier 42 multiplies an input vector A and a weight matrix W. The input vector A is vector data including Bc elements in which division input data a(x+i, y+j, co) is developed for each of i and j as described above. The weight matrix W is matrix data including Bc×Bd elements in which division weights w(i, j, co, do) are developed for each of i and j. The multiplier 42 includes Bc×Bd product-sum operation units 47 and can perform multiplication of the input vector A and the weight matrix W in parallel.

The multiplier 42 reads the input vector A and the weight matrix W required for multiplication from the first memory 1 and the weight memory 41 and performs the multiplication. The multiplier 42 outputs Bd product-sum operation results O(di).

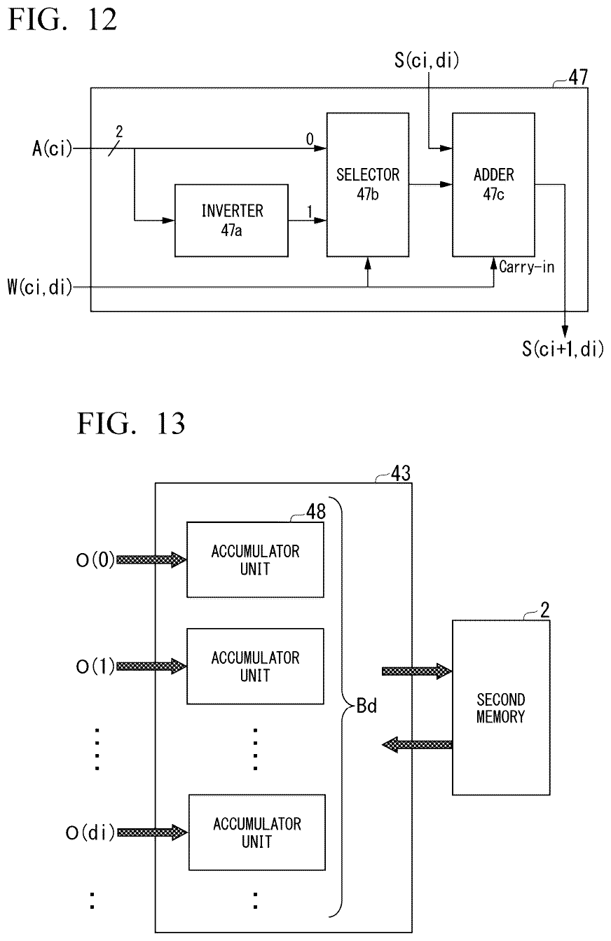

FIG. 12 is an internal block diagram of a product-sum operation unit 47.

The product-sum operation unit 47 performs multiplication of an element A(ci) of the input vector A and an element W(ci, di) of the weight matrix W. The product-sum operation unit 47 adds this multiplication result to the multiplication result S(ci, di) of another product-sum operation unit 47. The product-sum operation unit 47 outputs the addition result (S(ci+1, di). The element A(ci) is an unsigned integer (0, 1, 2, 3) of 2 bits. The element W(ci, di) is a signed integer (0, 1) of 1 bit, where the value “0” denotes +1 and the value “1” denotes −1.

The product-sum operation unit 47 includes an inverter 47a, a selector 47b, and an adder 47c. The product-sum operation unit 47 performs multiplication using only the inverter 47a and the selector 47b without using a multiplier. The selector 47b selects inputting of the element A(ci) when the element W(ci, di) is “0.” The selector 47b selects a complement obtained by inverting the element A(ci) using an inverter when the element W(ci, di) is “1.” The element W(ci, di) may be input to a carry-in of the adder 47c. The adder 47c outputs a value obtained by adding the element A(ci) to S(ci, di) when the element W(ci, di) is “0.” The adder 47c outputs a value obtained by subtracting the element A(ci) from S(ci, di) when the element W(ci, di) is “1.”

FIG. 13 is an internal block diagram of the accumulator circuit 43.

The accumulator circuit 43 accumulates the product-sum operation result O(di) of the multiplier 42 in the second memory 2. The accumulator circuit 43 includes Bd accumulator units 48 and can accumulate Bd product-sum operation results O(di) in the second memory 2 in parallel.

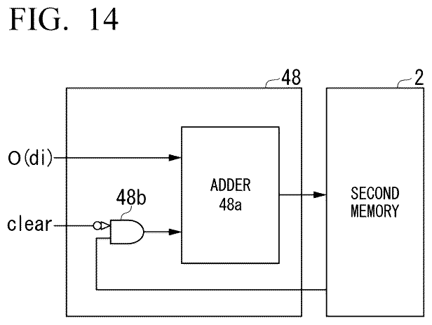

FIG. 14 is an internal block diagram of an accumulator unit 48.

The accumulator unit 48 includes an adder 48a and a mask unit 48b. The adder 48a adds an element O(di) which is a product-sum operation result O to a partial sum which is an intermediate result of the convolutional operation expressed by Expression 1 and stored in the second memory 2. The addition result has 16 bits per element. The addition result is not limited to 16 bits per element and may be, for example, 15 bits or 17 bits per element.

The adder 48a writes the addition result to the same address in the second memory 2. When an initialization signal clear is asserted, the mask unit 48b masks an output from the second memory 2 and sets an addition target to the element O(di) to zero. The initialization signal clear is asserted when the partial sum which is an intermediate result is not stored in the second memory 2.

When the convolutional operation using the multiplier 42 and the accumulator circuit 43 is completed, the output data f(x, y, do) is stored in the second memory 2.

The state controller 44 controls the states of the multiplier 42 and the accumulator circuit 43. The state controller 44 is connected to the controller 6 via the internal bus IB. The state controller 44 includes an instruction queue 45 and a control circuit 46.

The instruction queue 45 is a queue in which an instruction command C4 for the convolutional operation circuit 4 is stored and is constituted, for example, by a FIFO memory. The instruction command C4 is written to the instruction queue 45 via the internal bus IB.

The control circuit 46 is a state machine that decodes the instruction command C4 and controls the multiplier 42 and the accumulator circuit 43 on the basis of the instruction command C4. The control circuit 46 has the same configuration as the control circuit 34 of the state controller 32 of the DMAC 3.

### [Quantization Operation Circuit 5]

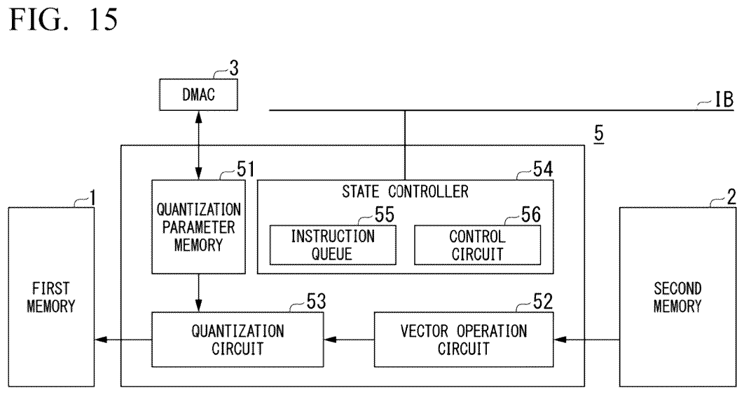

FIG. 15 is an internal block diagram of the quantization operation circuit 5.

The quantization operation circuit 5 includes a quantization parameter memory 51, a vector operation circuit 52, a quantization circuit 53, and a state controller 54. The quantization operation circuit 5 includes a state controller 54 dedicated for the vector operation circuit 52 and the quantization circuit 53 and can perform a quantization operation without requiring an external controller when an instruction command is input thereto.

The quantization parameter memory 51 is a memory in which quantization parameters q used for the quantization operation are stored and is, for example, a rewritable memory such as a volatile memory constituted by a static RAM (SRAM). The DMAC 3 writes the quantization parameters q required for the quantization operation to the quantization parameter memory 51 through DMA transfer.

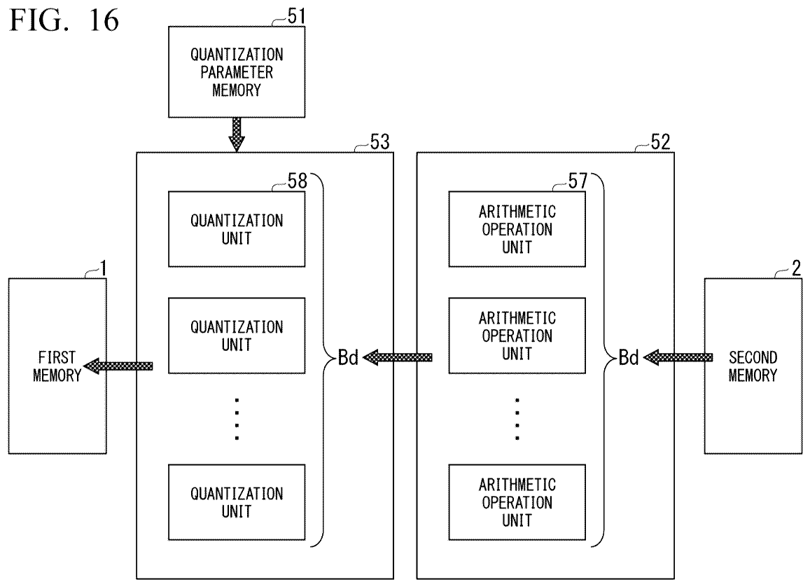

FIG. 16 is an internal block diagram of the vector operation circuit 52 and the quantization circuit 53.

The vector operation circuit 52 performs an arithmetic operation on the output data f(x, y, do) stored in the second memory 2. The vector operation circuit 52 includes Bd arithmetic operation units 57 and performs an SIMD operation on the output data f(x, y, do) in parallel.

FIG. 17 is a block diagram of the arithmetic operation unit 57.

The arithmetic operation unit 57 includes, for example, an ALU 57a, a first selector 57b, a second selector 57c, a register 57d, and a shifter 57e. The arithmetic operation unit 57 may further include another operator included in a known general-purpose SIMD operation circuit.

The vector operation circuit 52 performs at least one operation of the operations of the pooling layer 221, the batch normalization layer 222, and the activation function layer 223 in the quantization operation layer 220 on the output data f(x, y, do) in combination with an operator or the like provided in the arithmetic operation unit 57.

The arithmetic operation unit 57 can add the elements f(di) of the output data f(x, y, do) read from the second memory 2 to the data stored in the register 57d using the ALU 57a. The arithmetic operation unit 57 can store an addition result from the ALU 57a in the register 57d. The arithmetic operation unit 57 can initialize the addition result by inputting “0” to the ALU 57a instead of the data stored in the register 57d through selection in the first selector 57b. For example, when a pooling area is 2×2, the shifter 57e can output an average value of the addition results by shifting the output of the ALU 57a to the right by 2 bits. The vector operation circuit 52 can perform an average pooling operation expressed by Expression 2 by repeating the arithmetic operations in the Bd arithmetic operation units 57 or the like.

The arithmetic operation unit 57 can compare the elements f(di) of the output data f(x, y, do) read from the second memory 2 with the data stored in the register 57d using the ALU 57a.

The arithmetic operation unit 57 can control the second selector 57c on the basis of the comparison result from the ALU 57a such that the larger of the data stored in the register 57d and the element f(di) is selected. The arithmetic operation unit 57 can initialize a comparison target to a minimum value by inputting the minimum value of values which can be taken by the element f(di) to the ALU 57a through selection in the first selector 57b. In the present embodiment, since the element f(di) is a signed integer of 16 bits, the minimum value of values which can be taken by the element f(di) is “0x8000.” The vector operation circuit 52 can perform the MAX pooling operation of Expression (3) by repeating the operations of the Bd arithmetic operation units 57. In the MAX pooling operation, the shifter 57e does not shift the output of the second selector 57c.

The arithmetic operation unit 57 can subtract the element f(di) of the output data f(x, y, do) read from the second memory 2 from the data stored in the register 57d using the ALU 57a. The shifter 57e can shift the output of the ALU 57a to the left (that is, multiplication) or shift the output to the right (that is, division). The vector operation circuit 52 can perform the batch normalization operation expressed by Expression 4 by repeating the operations of the Bd arithmetic operation units 57.

The arithmetic operation unit 57 can compare “0” selected by the first selector 57b with the element f(di) of the output data f(x, y, do) read from the second memory 2 using the ALU 57a. The arithmetic operation unit 57 can select and output one of the element f(di) and the constant value “0” stored in advance in the register 57d on the basis of the comparison result from the ALU 57a. The vector operation circuit 52 can perform the ReLU operation expressed by Expression 5 by repeating the operations of the Bd arithmetic operation units 57.

The vector operation circuit 52 can perform the arithmetic operations of the average pooling, the MAX pooling, the batch normalization, and the activation function, and combination of these arithmetic operations. The vector operation circuit 52 can perform a general-purpose SIMD operation and thus may perform another arithmetic operation required for the operation in the quantization operation layer 220. The vector operation circuit 52 may perform an arithmetic operation other than the arithmetic operation in the quantization operation layer 220.

The quantization operation circuit 5 may not include the vector operation circuit 52. When the quantization operation circuit 5 does not include the vector operation circuit 52, the output data f(x, y, do) is input to the quantization circuit 53.

The quantization circuit 53 performs quantization of the output data from the vector operation circuit 52. The quantization circuit 53 includes Bd quantization units 58 as illustrated in FIG. 16 and performs the arithmetic operations of the output data from the vector operation circuit 52 in parallel.

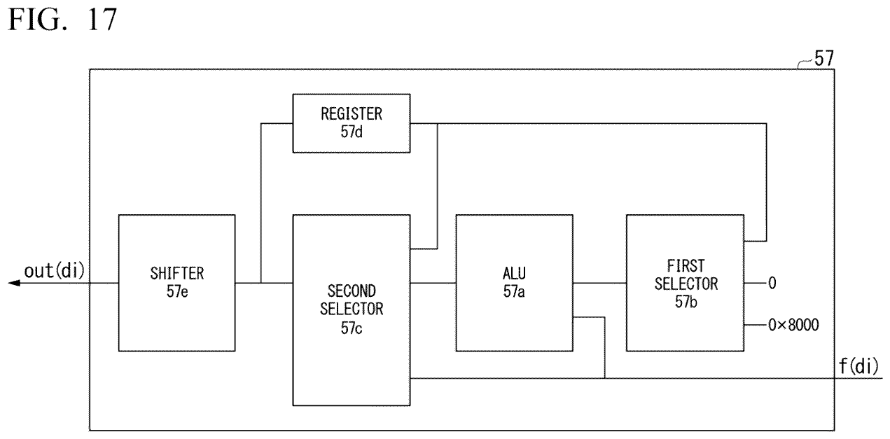

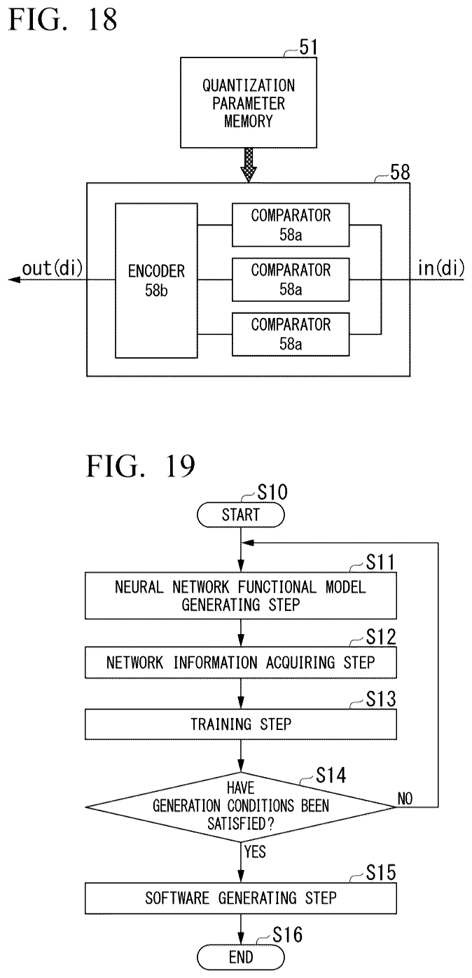

FIG. 18 is an internal block diagram of a quantization unit 58.

Each quantization unit 58 performs quantization of each element in(di) of the output data of the vector operation circuit 52. The quantization unit 58 includes a comparator 58a and an encoder 58b. The quantization unit 58 performs an arithmetic operation of the quantization layer 224 (Expression 6) in the quantization operation layer 220 on the output data (16 bits/elements) of the vector operation circuit 52. The quantization unit 58 reads necessary quantization parameters q(th0, th1, th2) from the quantization parameter memory 51 and compares the quantization parameter q with the input in(di) using the comparator 58a. The quantization unit 58 outputs an output out(di) obtained by encoding the comparison result from the comparator 58a into 2 bits/elements using the encoder 58b. Since α(c) and β(c) in Expression 4 are parameters differing depending on the variable c, the quantization parameters q(th0, th1, th2) in which α(c) and β(c) are reflected are parameters differing depending on the input in(di).

The quantization unit 58 classifies the input in(di) into four areas (for example, in≤th0, th0<in≤th1, th1<in≤th2, th2<in) by comparing the input in(di) with three threshold values th0, th1, and th2 and encodes and outputs the classification result in 2 bits. The quantization unit 58 may perform the arithmetic operation of the batch normalization or the activation function along with the quantization by setting the quantization parameters q(th0, th1, th2).

The quantization unit 58 can perform the arithmetic operation of the batch normalization expressed by Expression 4 along with the quantization by setting the threshold value th0 to β(c) expressed by Expression 4, setting differences in threshold value (th1−th0) and (th2−th1) to α(c) expressed by Expression 4, and performing the quantization. α(c) can be decreased by increasing the threshold values (th1−th0) and (th2−th1). α(c) can be increased by decreasing the threshold values (th1−th0) and (th2−th1).

The quantization unit 58 can perform the arithmetic operation of the activation function along with quantization of the input in(di). For example, the quantization unit 58 saturates an output value in the areas of in(di)≤th0 and th2<in(di). The quantization unit 58 can perform the arithmetic operation of the activation function along with the quantization by setting the quantization parameter q such that the output becomes nonlinear.

The state controller 54 controls the states of the vector operation circuit 52 and the quantization circuit 53. The state controller 54 is connected to the controller 6 via the internal bus IB. The state controller 54 includes an instruction queue 55 and a control circuit 56.

The instruction queue 55 is a queue in which an instruction command C5 for the quantization operation circuit 5 is stored and is constituted, for example, by a FIFO memory. One or more instruction commands C5 are written to the instruction queue 55 via the internal bus IB.

The control circuit 56 is a state machine that decodes the instruction command C5 and controls the vector operation circuit 52 and the quantization circuit 53 on the basis of the instruction command C5. The control circuit 56 has the same configuration as the control circuit 34 of the state controller 32 of the DMAC 3.

The quantization operation circuit 5 writes the quantization operation output data including Bd elements to the first memory 1. An appropriate relationship between Bd and Bc is expressed by Expression 10. In Expression 10, n is an integer.

$$\begin{matrix}[ Math . 10 ] & \\ B d = {2}^{n} \cdot Bc & [ Expression 10 ]\end{matrix}$$

### [Controller 6]

The controller 6 transfers an instruction command transmitted from an external host CPU to the instruction queue provided in the DMAC 3, the convolutional operation circuit 4, and the quantization operation circuit 5. The controller 6 may include an instruction memory in which instruction command for the circuits are stored.

The controller 6 is connected to the external bus EB and serves as a slave of the external host CPU. The controller 6 includes a register 61 including parameter register or a state register. The parameter register is a register that controls the operation of the NN circuit 100. The state register is a register that indicates the state of the NN circuit 100 including the semaphore S.

### [Operation of Neural Network Training Device 300]

The operation (the neural network training method) of the neural network training device 300 will be described below with reference to the control flowchart for the neural network training device 300 illustrated in FIG. 19. The neural network training device 300 performs an initialization process and then performs the process of Step S11.

### <Neural Network Functional Model Generating Step (S11)>

In Step S11, the functional model generating unit 326 of the neural network training device 300 generates a CNN 200 and outputs network information NW1 which is information on the CNN 200 (a neural network functional model generating step). For example, the functional model generating unit 326 generates the CNN 200 by displaying a GUI image for setting the CNN 200 on the display unit 350 and allowing a user to input necessary information from the operation input unit 360.

The functional model generating unit 326 may include a library or a platform (for example, TensorFlow or PyTorch) that can generate a functional model of a known neural network.

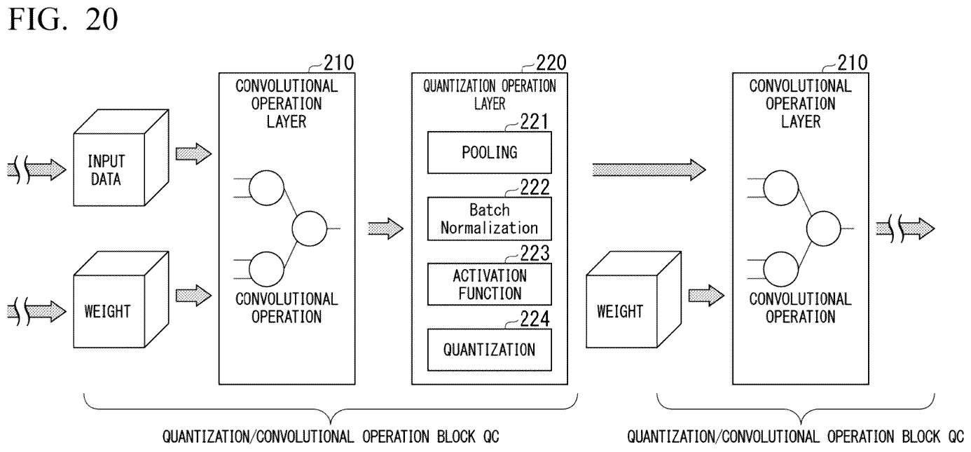

FIG. 20 is a diagram illustrating an example of a GUI image for setting a NN functional model 200.

The functional model generating unit 326 sets a network structure or specifications for each layer in the CNN 200 (the NN functional model 200) on the basis of a user's input from the operation unit input 360. For example, a user changes the network structure of the NN functional model 200 by reconfiguring connections of layers which are displayed in the GUI image and which are visually schematized. The user changes the specifications (such as input data information, output data information, and quantization information) for the layers which are displayed in the GUI image and which are visually schematized. For example, the user can reconfigure connections of the pooling layer 221, the batch normalization layer 222, the activation function layer 223, and the quantization layer 224 in the quantization operation layer 220.

The network structure or the specifications for each layer in the CNN 200 (the NN functional model 200) may not be visually schematized as illustrated in FIG. 20. The network structure or the specifications for each layer in the CNN 200 may be described in a program language, XML, or the like.

The CNN 200 (the NN functional model 200) generated by the functional model generating unit 326 is a neural network functional model that can perform a training operation and an inference operation using the arithmetic operation unit 320 (the training unit 322 and the inference unit 323) of the neural network training device 300. The arithmetic operation unit 320 of the neural network training device 300 includes an arithmetic operation circuit with higher performance than the arithmetic operation circuit included in the NN circuit 100 and is, for example, a CPU, a GPU, or dedicated hardware. Accordingly, the CNN 200 generated by the functional model generating unit 326 can include an arithmetic operation block (hereinafter also referred to as a “convertible operation block”) that can be converted to an arithmetic operation which can be performed in the NN circuit 100 and an arithmetic operation block (hereinafter also referred to as a “nonconvertible operation block”) that cannot be converted to an arithmetic operation which can be performed in the NN circuit 100. Here, the arithmetic operation block includes a plurality of successive arithmetic operations in the CNN 200.

In order to cause the NN circuit 100 to efficiently perform an inference operation of the CNN 200 (the NN functional model 200), it is preferable that the functional model generating unit 326 generate more arithmetic operation blocks (convertible operation blocks) that can be converted to arithmetic operations which can be performed in the NN circuit 100.

As illustrated in FIG. 20, arithmetic operation blocks of from a convolutional operation to a quantization operation which are a part of the CNN 200 (the NN functional model 200) are defined as “quantization/convolutional operation blocks QC”. At least a part of the CNN 200 is constituted by connecting a plurality of quantization/convolutional operation blocks QC.

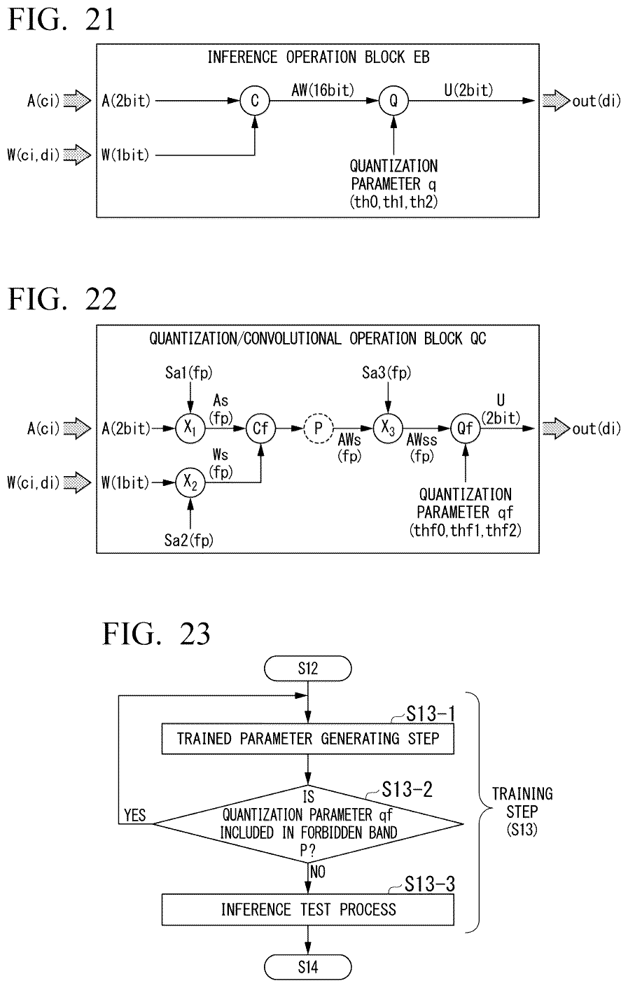

FIG. 21 is a diagram illustrating an inference operation block EB in the NN circuit 100.

In the NN circuit 100 which is formed in a loop shape, an arithmetic operation block in a loop shape formed by the first memory 1, the convolutional operation circuit 4, the second memory 2, and the quantization operation circuit 5 is defined as an “inference operation block EB.”

“C” illustrated in FIG. 21 denotes an arithmetic operation of the product-sum operation unit 47 in the convolutional operation circuit 4. “AW” illustrated in FIG. 21 denotes data which is obtained by multiplying an input vector A by a weight matrix W and is vector data including an integer of 16 bits for each element.

“Q” illustrated in FIG. 21 denotes an arithmetic operation of the quantization circuit 53 in the quantization operation circuit 5. “U” illustrated in FIG. 21 denotes data which is obtained by quantizing AW and is vector data including an integer of 2 bits for each element. In the inference operation block EB illustrated in FIG. 21, the vector operation circuit 52 in the quantization circuit 53 is omitted to simplify the description of the function of the neural network training device 300.

An operation environment (such as operation accuracy, a data format, and the operation order) in the inference operation block EB illustrated in FIG. 21 matches an operation environment (such as operation accuracy, a data format, and the operation order) in the NN circuit 100 illustrated in FIG. 6. When the operation environment in the NN circuit 100 changes, the operation environment in the inference operation block EB changes according to the operation environment in the NN circuit 100.

FIG. 22 is a diagram illustrating a quantization/convolutional operation blocks QC in the CNN 200.

The quantization/convolutional operation block QC illustrated in FIG. 22 is configured as a convertible operation block and outputs an output vector U which is quantized in 2 bits for each element when the input vector A and the weight matrix W are input thereto.

“X₁” illustrated in FIG. 22 denotes an arithmetic operation (a post-quantization postscaler) of performing an affine transformation operation with first scaling factors Sa1 and Sb1 in a floating decimal point format as coefficients on the input vector A (Sa1×A+Sb1) and outputting vector data As in a floating decimal point format. When the quantization/convolutional operation blocks QC are configured as convertible operation blocks, the input data is limited to an input vector A including 2 bits for each element. In this case, it is possible to curb a decrease in accuracy of input data by performing an affine transformation with the first scaling factors Sa1 and Sb1 as coefficients on the input vector A.

“X₂” illustrated in FIG. 22 denotes an arithmetic operation of performing an affine transformation operation with second scaling factors Sa2 and Sb2 in a floating decimal point format as coefficients on the weight matrix W (Sa2×W+Sb2) and outputting matrix data Ws in a floating decimal point format. When the quantization/convolutional operation blocks QC are configured as convertible operation blocks, the weights are limited to a weight matrix W including 1 bit for each element. In this case, it is possible to curb a decrease in accuracy of the weights by performing an affine transformation with the scaling factors Sa2 and Sb2 as coefficients on the weight matrix W.

“Cf” illustrated in FIG. 22 denotes a convolutional operation of multiplying As by Ws and outputting vector data Aws in the floating decimal point format.

“X₃” illustrated in FIG. 22 denotes an arithmetic operation (a pre-quantization prescaler) of performing an affine transformation operation with third scaling factors Sa3 and Sb3 in a floating decimal point format as coefficients on the vector data AWs (Sa3×AWs+Sb3) and outputting vector data AWss in the floating decimal point format. For example, “X₃” is a prescaler corresponding to “X₁” (the post-quantization postscaler).

“Qf” illustrated in FIG. 22 denotes a quantization operation of performing quantization of the vector data AWss in the floating decimal point format on the basis of quantization parameters qf(thf0, thf1, thf2) and outputting vector data U including an integer of 2 bits for each element. The quantization parameters qf are threshold values (thf0, thf1, thf2) in the floating decimal point format. When the quantization/convolutional operation blocks QC are configured as convertible operation blocks, the output data is limited to vector data U including 2 bits for each element.

The quantization/convolutional operation block QC illustrated in FIG. 22 can be handled as a convertible operation block that can be converted to an arithmetic operation which can be performed in an inference operation block EB by taking and concentrating the scaling factors (Sa1, Sb1, Sa2, Sb2, Sa3, Sb3) on the quantization parameters qf(thf0, thf1, thf2) in the quantization operation Qf. For example, when Sa1 is 1.5, Sa2 is 2.0, and Sa3 is 1.1, the scaling factors are concentrated on the quantization parameters qf by updating the quantization parameters qf(thf0, thf1, thf2) in the quantization operation Q with a value of 1/3.3 times the original quantization parameters.

When another type of arithmetic operation P is added, the quantization/convolutional operation block QC can be configured as a convertible operation block according to the type of the arithmetic operation P. For example, the batch normalization operation or the activation function operation can be taken and concentrated on the quantization parameters qf(thf0, thf1, thf2) as described above. Addition of a bias value to the convolutional operation result can be taken and concentrated on the quantization parameters qf by subtracting the bias value from the quantization parameters qf. Accordingly, even when another type of arithmetic operation P such as batch normalization, activation function, or addition of a bias value is added, the quantization/convolutional operation block QC can be configured as a convertible operation block. When the arithmetic operation P is an arithmetic operation that cannot be taken and concentrated on the quantization parameters qf, an operation block including the arithmetic operation P is an inconvertible operation block.

When the arithmetic operation P includes a plurality of floating-decimal-point arithmetic operations, it is preferable that the plurality of floating-decimal-point arithmetic operations be performed in the order in which a rounding error is less likely to occur. This is because, when the rounding error is likely to occur, an error between an operation result from a quantization/convolutional operation block QC and an operation result from an inference operation block EB is more likely to occur due to variations of the rounding error which will be described later.

### <Network Information Acquiring Step (S12)>

In Step S12, the neural network training device 300 acquires network information NW of the CNN 200 generated in the neural network generating step (S10) (a network information acquiring step). When network information NW is generated by another device, the neural network training device 300 acquires the network information NW generated by the other device.

The acquired network information NW is stored in the storage unit 310. Then, the neural network training device 300 performs Step S13.

### <Training Step (S13)>

FIG. 23 is a flowchart illustrating a training step.

In Step S13, the training unit 322 and the inference unit 323 of the neural network training device 300 learn trained parameters of the generated CNN 200 (the NN functional model 200) using the training data set DS (a training step). The training step (S13) includes, for example, a trained parameter generating step (S13-1), a forbidden band ascertaining step (S13-2), and an inference test step (S13-3).

### <Training Step: Trained Parameter Generating Step (S13-1)>

The training unit 322 generates trained parameters PM using network information NW1 for defining a configuration or a function of the CNN 200 or training data D1. The trained parameters PM include weights w, quantization parameters qf, and scaling factors (Sa1, Sa2, Sa3).

For example, when the CNN 200 is a model of a neural network performing image recognition, the training data D1 is a combination of an input image and training data T. The input image is input data a that is input to the CNN 200. The training data T includes a type of a subject captured in an image, information indicating whether an object to be detected is present in an image, and coordinate values of an object to be detected in an image.

The training unit 322 generates a trained parameter PM through supervised learning such as an error backward propagation algorithm which is a known technique. The training unit 322 calculates a difference E between an output from the CNN 200 (the NN functional model 200) in response to an input image and the training data T corresponding to the input image using a loss function (an error function) and updates the weights w, the quantization parameters qf, and the scaling factors such that the difference E decreases. The training unit 322 concentrates the scaling factors or the arithmetic operations P (the arithmetic operations P that can be concentrated on the quantization parameters qf) on the quantization parameters qf and determines final quantization parameters qf.

For example, when the weights w are updated, a gradient of a loss function for the weights w is used. The gradient is calculated, for example, by differentiating the loss function. When an error backward propagation algorithm is used, the gradient is calculated through backward propagation.

### <Training Step: Forbidden Band Ascertaining Step S13-2)>

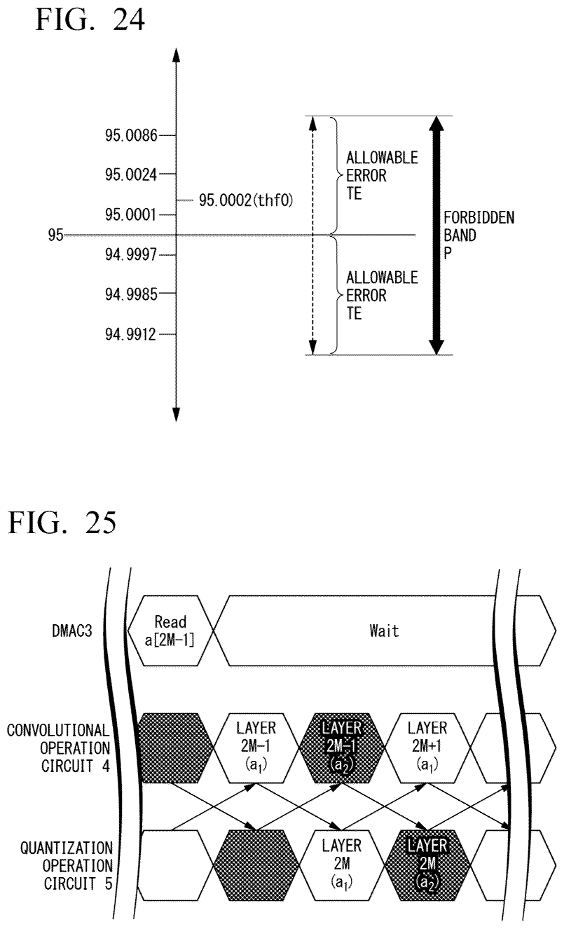

FIG. 24 is a diagram illustrating a forbidden band P of a quantization parameter qf.

The training unit 322 determines whether the generated quantization parameter qf is included in a forbidden band P. The forbidden band P is a numerical range of integer value±allowable error TE. The allowable error TE is a value infinitely close to zero such as a machine epsilon, le-5, or le-10.

A convolutional operation C in the inference operation block EB is an integer arithmetic operation, and thus an error does not occur. All operation results which logically become “95” are “95.” Since the threshold values (th0, th1, th2) of the quantization parameters q are integers, an error does not occur in the quantization operation as well.

On the other hand, since the affine transformation operations (X₁, X₂, and X₃), the convolutional operations Cf, and the like in the quantization/convolutional operation blocks QC are floating-decimal-point arithmetic operations, a variation of a rounding error occurs in the operation results. For example, as illustrated in FIG. 24, the operation results which logically become “95” may be, for example, {94.9912, 94.9985, 94.9997, 95.0001, 95.0024, 95.0086} due to a variation of the rounding error. When a threshold value thf0 which is one of the quantization parameters qf is 95.0002, quantization data obtained by quantizing the 6 operation results is {0, 0, 0, 0, 1, 1}, all of which are not the same value.

In this way, a mismatch may occur in quantization data obtained by quantizing the operation results which logically become an “integer value” using a threshold value between the inference operation block EB and the quantization/convolutional operation block QC. When this mismatch occurs, an error occurs between the operation result from the quantization/convolutional operation block QC and the operation result from the inference operation block EB. When this error occurs, a result of a training operation in the quantization/convolutional operation block QC and a result of an inference operation in the inference operation block EB obtained by quantizing the result of the convolutional operation to an integer value may not match.

Therefore, the training unit 322 may acquire an error which occurs on the basis of a difference between an operation environment (such as arithmetic accuracy, data format, and arithmetic order) in the quantization/convolutional operation block QC and an operation environment (such as arithmetic accuracy, data format, and arithmetic order) in the inference operation block EB in advance and update the quantization parameters qf such that the error decreases. Here, the training unit 322 needs to ascertain the operation environment in the inference operation block EB in order to recognize the difference in the operation environment. For example, the training unit 322 may acquire a setting file in which design parameters associated with the NN circuit 100 are set or the like and ascertain the operation environment in the inference operation block EB. The training unit 322 may display a GUI image or a console image for setting the design parameters associated with the NN circuit 100 on the display unit 350, allow a user to input necessary information via the operation input unit 360, and ascertain the operation environment in the inference operation block EB.

The training unit 322 may provide a forbidden band P in a range which can be taken by each of the quantization parameters qf. It is assumed that the training unit 322 accumulates a variation of the rounding error in the quantization/convolutional operation block QC in the range of the allowable error TE. When a quantization parameter qf is included in the forbidden band P which is a numerical range of integer value±allowable error TE, the training unit 322 determines the quantization parameter qf to be a parameter which may cause a mismatch in quantization data and does not employ the quantization parameter qf as a quantization parameter.

When a quantization parameter qf is included in the forbidden band P, the training unit 322 performs the trained parameter generating step (S13-1) again and generates a new quantization parameter qf. The training unit 322 may generate a new quantization parameter qf by changing the order of floating-decimal-point arithmetic operations when the scaling factors or the arithmetic operations P (arithmetic operations P which can be concentrated on the quantization parameter qf) on the quantization parameter qf. The training unit 322 performs these processes until the quantization parameter qf is not included in the forbidden band P.

The forbidden band P is appropriately determined in advance according to the operation environment (such as arithmetic accuracy, data format, and arithmetic order) in the quantization/convolutional operation block QC, the operation environment (such as arithmetic accuracy, data format, and arithmetic order) in the inference operation block EB, the allowable error range, and the like.

The quantization/convolutional operation block QC illustrated in FIG. 22 is an arithmetic operation block performing a floating-decimal-point arithmetic operation, but the operation environment of the quantization/convolutional operation block QC is not limited thereto. For example, the quantization/convolutional operation block QC may be an arithmetic operation block performing an integer arithmetic operation. In this case, an error does not occur between the operation result from the quantization/convolutional operation block QC and the operation result from the inference operation block EB. For example, the quantization/convolutional operation block QC performs an integer arithmetic operation with a decimal part of data in a floating decimal point format (such as a scaling factor) as zero and with data as an integer value.

Then, the training unit 322 performs an inference test step (S13-3) when the quantization parameter qf is not included in the forbidden band P which is a numerical range of integer value±allowable error TE.

### <Training Step: Inference Test Step (S13-3)>

The inference unit 323 performs an inference test using the trained parameters PM generated by the training unit 322 and test data D2. For example, when the CNN 200 is a model of a neural network that performs image recognition, the test data D2 is a combination of an input image and training data T similarly to the training data D1.

The inference unit 323 displays the progress and the result of the inference test on the display unit 350. The result of the inference test is, for example, a correct answer rate with respect to the test data D2.

### <Ascertainment Step (S14)>

In Step S14, the inference unit 323 of the neural network training device 300 displays a message for prompting a user to input ascertainment of a result via the operation input unit 360 or a GUI image required for inputting information on the display unit 350. The user inputs information indicating whether to permit the result of the inference test via the operation input unit 360. When information indicating that the user permits the result of the inference test is input via the operation input unit 360, the neural network training device 300 then performs Step S15. When information indicating that the user does not permit the result of the inference test is input via the operation input unit 360, the neural network training device 300 then performs Step S11 again to regenerate a CNN 200 (a NN functional model 200) and to re-output network information NW (a neural network functional model regenerating step). In Step S11 which is re-performed, the user changes, for example, quantization information (whether to quantize each layer) or input data information (such as the number of channels).

### <Software Generating Step (S15)>

In Step S15, the software generating unit 325 of the neural network training device 300 generates software 500 for activating the NN circuit 100 on the basis of the network information NW1 for defining the configuration or the function of the CNN 200 and the inference network information NW2. The software 500 is, for example, software using an instruction set for controlling the NN circuit 100. The software 500 includes software for transferring the trained parameters PM to the NN circuit 100 according to necessity.

The software generating step (S15) includes, for example, a conversion step (S15-1) and an allocation step (S15-2).

### <Conversion Step (S15-1)>

The software generating unit 325 converts the NN functional model 200 to an arithmetic operation block convertable to the arithmetic operation that can be performed by the NN circuit 100 in the NN circuit 100 on the basis of the inference network information NW2 which is information on an inference operation performed by the NN circuit 100. The software generating unit 325 generates software 500 for causing the NN circuit 100 or the like to perform the arithmetic operation of the arithmetic operation block which is a conversion result.

The quantization/convolutional operation block QC configured as a convertible operation block is converted to the software 500 for causing the NN circuit 100 to perform the arithmetic operation of the arithmetic operation block which is a conversion result. The quantization parameters qf generated and updated in the training step are converted to quantization parameters q of integer values in the conversion step.

The quantization/convolutional operation block QC configured as an inconvertible operation block is converted to the software 500 for causing an external arithmetic device such as an external host CPU to perform the arithmetic operation of the arithmetic operation block which is a conversion result or the software 500 for causing a combination of the external arithmetic device such as the external host CPU and the NN circuit 100 to perform the arithmetic operation.

### <Allocation Step (S15-2)>

The software generating unit 325 generates software 500 for allocating divided arithmetic operations to the NN circuit 100 to perform the divided arithmetic operations (an allocation step). The generated software 500 includes an instruction command C3, an instruction command C4, and an instruction command C5.

FIG. 25 is a timing chart illustrating an example of allocation to the NN circuit 100.

A convolutional operation and a quantization operation corresponding to a first partial tensor a₁ and a convolutional operation and a quantization operation corresponding to a second partial tensor a₂ can be performed independently as illustrated in FIG. 25. Therefore, the software generating unit 325 may allocate the divided arithmetic operations to the NN circuit 100 by changing the order of some of the networks (the layers).

The convolutional operation circuit 4 performs a convolutional operation of Layer 2M−1 (an arithmetic operation indicated by Layer 2M−1 (a₁) in FIG. 25) corresponding to the first partial tensor a₁. Thereafter, the convolutional operation circuit 4 performs a convolutional operation of Layer 2M−1 (an arithmetic operation indicated by Layer 2M−1 (a₂) in FIG. 25) corresponding to the second partial tensor a₂. In addition, the quantization operation circuit 5 performs a quantization operation of Layer 2M (an arithmetic operation indicated by Layer 2M (a₁) in FIG. 25) corresponding to the first partial tensor a₁. In this way, the NN circuit 100 can perform the convolutional operation of Layer 2M−1 corresponding to the second partial tensor a₂ and the quantization operation of Layer 2M corresponding to the first partial tensor a₁ in parallel.

Then, the convolutional operation circuit 4 performs a convolutional operation of Layer 2M+1 (an arithmetic operation indicated by Layer 2M+1 (a₁) in FIG. 25) corresponding to the first partial tensor a₁. In addition, the quantization operation circuit 5 performs a quantization operation of Layer 2M (an arithmetic operation indicated by Layer 2M (a₂) in FIG. 25) corresponding to the second partial tensor a₂. In this way, the NN circuit 100 can perform the convolutional operation of Layer 2M+1 corresponding to the first partial tensor a₁ and the quantization operation of Layer 2M corresponding to the second partial tensor a₂ in parallel.

By dividing input data a into partial tensors, the NN circuit 100 can activate the convolutional operation circuit 4 and the quantization operation circuit 5 in parallel. As a result, it is possible to reduce a time in which the convolutional operation circuit 4 and the quantization operation circuit 5 wait and to improve operation processing efficiency of the NN circuit 100. The number of divisions into the partial tensors in the operation example illustrated in FIG. 25 is 2, but the NN circuit 100 can similarly activate the convolutional operation circuit 4 and the quantization operation circuit 5 in parallel even in a case in which the number of divisions is greater than 2.

An example (Method 1) in which arithmetic operations of the partial tensors in the same layer are first performed by the convolutional operation circuit 4 or the quantization operation circuit 5 and then arithmetic operations of the partial tensors in a next layer are performed has been described as an arithmetic operation method for the partial tensors. For example, as illustrated in FIG. 25, the convolutional operation circuit 4 performs convolutional operations of Layer 2M−1 (arithmetic operations indicated by Layer 2M−1 (a₁) and Layer 2M−1 (a₂) in FIG. 25) corresponding to the first partial tensor a₁ and the second partial tensor a₂ and then performs convolutional operations of Layer 2M+1 (arithmetic operations indicated by Layer 2M+1 (a₁) and Layer 2M+1 (a₂) in FIG. 25) corresponding to the first partial tensor a₁ and the second partial tensor a₂.

However, the arithmetic operation method for the partial tensors is not limited thereto. The arithmetic operation method for the partial tensors may be a method of first performing the arithmetic operations of some partial tensors in a plurality of layers and then performing the arithmetic operations of the remaining partial tensors (Method 2). For example, the convolutional operation circuit 4 may first perform the convolutional operations of Layer 2M−1 corresponding to the first partial tensor a₁ and Layer 2M+1 corresponding to the second partial tensor a₁ and then perform the convolutional operations of Layer 2M−1 corresponding to the second partial tensor a₂ and Layer 2M+1 corresponding to the second partial tensor a₂.

The arithmetic operation method for the partial tensors may be a method of performing an arithmetic operation for the partial tensors in combination of Method 1 and Method 2. Here, when Method 2 is used, the arithmetic operations need to be performed according to a dependency relationship between the partial tensors with respect to the arithmetic order.

Whether the parallel arithmetic operation of the partial tensors is to be performed is determined on the basis of an unused area of the first memory 1 or the second memory 2 in addition to the dependency relationship between the partial tensors with respect to the arithmetic order. When an unused area required for the parallel arithmetic is not present in the first memory 1 or the second memory 2, control for not performing some arithmetic operations of the parallel arithmetic operations in parallel but performing them in a time division manner is performed.

For example, when the convolutional operation with the weight w varying is performed on the same input data a, it is more efficient to perform the convolutional operation using the same input data a successively. Accordingly, the software generating unit 325 changes the order of divided arithmetic operations such that arithmetic operations using the same data stored in the first memory 1 or the second memory 2 are performed as successively as possible.

With the neural network training device 300 and the neural network training method according to the present embodiment, when a quantization/convolutional operation block QC of a CNN 200 (a NN functional model 200) performing a convolutional operation and a quantization operation in a floating decimal point format is converted to an arithmetic operation that can be performed in an inference operation block EB of the NN circuit 100 performing a convolutional operation and a quantization operation in an integer format and an inference operation is performed, it is possible to curb occurrence of an error between an operation result from the quantization/convolutional operation block QC and an operation result from the inference operation block EB.

This error occurs because an operation environment in which a training operation is performed (a training operation environment) and an operation environment in which an inference operation is performed (an inference operation environment) are different. When the training operation environment is an arithmetic operation device with high performance including an arithmetic operation based on a floating decimal point format and the inference operation environment is an edge device that performs an arithmetic operation based on an integer format, the error is more likely to occur. With the neural network training device 300 and the neural network training method according to the present embodiment, even when the training operation environment is an arithmetic operation based on the floating decimal point format and the inference operation environment is an arithmetic operation based on the integer format, it is possible to curb occurrence of the error by providing a forbidden band P in updating the quantization parameters qf.

The CNN 200 (the NN functional model 200) described in the present embodiment is a neural network not including a subnetwork (a subgraph). However, the CNN 200 (the NN functional model 200) may include a subnetwork (a subgraph).

While the first embodiment of the present invention has been described above in detail with reference to the drawings, a specific configuration thereof is not limited to this embodiment and includes a design change without departing from the gist of the present invention. Constituents in the aforementioned embodiment and modified examples can be appropriately combined into a configuration.

### Modified Example 1

In the aforementioned embodiment, the first memory 1 and the second memory 2 are different memories, but the first memory 1 and the second memory 2 are not limited to this aspect. The first memory 1 and the second memory 2 may be, for example, a first memory area and a second memory area in the same memory.

### Modified Example 2

For example, data input to the NN circuit 100 described in the aforementioned embodiment is not limited to a single format and can be configured as a still image, a video, speech, text, numerical values, and combinations thereof. Data input to the NN circuit 100 is not limited to measurement results in physical quantity sensors such as an optical sensor, a thermometer, a global positioning system (GPS) sensor, an angular velocity sensor, and a wind speed sensor that can be mounted in an edge device with which the NN circuit 100 is provided. Different types of information such as periphery information such as base station information received from peripheral devices by wired or wireless communication, information of a vehicle, a ship, or the like, weather information, and information of a congestion situation, financial information, and personal information may be combined.

### Modified Example 3

An edge device in which the NN circuit 100 is provided is assumed to be a communication device such as a mobile phone driven with a battery or the like, a smart device such as a personal computer, a digital camera, a game machine, or a mobile device such as a robot product, but is not limited thereto. In comparison with the prior art, it is possible to obtain an advantageous effect of applying the edge device to products much requiring limitation of peak power suppliable to Power on Ethernet (POE), reduction of heating of a product, or driving for a long time. For example, by applying the present invention to an onboard camera which is mounted in a vehicle, a ship, or the like, a monitoring camera which is provided in public facilities, road surfaces, or the like, or the like, it is possible to realize imaging for a long time and to contribute to a decrease in weight and an increase in durability. By applying the present invention to a display device such as a television or a display, a medical device such as a medical camera or a surgery robot, a working robot which is used in a manufacturing site or a construction site, and the like, it is possible to achieve the same advantageous effects.

### (Modified Example 4)

The NN circuit 100 may realize a part or the whole part of the NN circuit 100 using one or more processors. For example, the NN circuit 100 may realize a part or the whole part of an input layer or an output layer through software processes using a processor. The part of the input layer or the output layer realized through the software processes is, for example, normalization or conversion of data. Accordingly, it is possible to cope with input formats or output formats of various formats. Software which is performed by the processor may be configured to be rewritable using a communication means or external media.

### Modified Example 5

The NN circuit 100 may realize some of the processes of the CNN 200 by combining graphics processing units (GPUs) in cloud. The NN circuit 100 can realize more complex processes with less resources by performing processes in cloud in addition to the processes performed by an edge device in which the NN circuit 100 is provided or performing processes in the edge device in addition to the processes in cloud. With this configuration, the NN circuit 100 can distribute the processes to reduce the amount of communication between the edge device and the cloud.

The advantageous effects described in this specification are explanatory or exemplary, but are not restrictive. That is, the technique according to the present disclosure can achieve other advantageous effects apparent to those skilled in the art from the description of this specification in addition to the advantageous effects or instead of the advantageous effects.

### INDUSTRIAL APPLICABILITY

The present invention is applicable to an arithmetic operation of a neural network.

### REFERENCE SIGNS LIST

500 Software
300 Neural network training device
200 Convolutional neural network (CNN. NN function model)
100 Neural network circuit (NN circuit)
1 First memory
2 Second memory
3 DMA controller (DMAC)
4 Convolutional operation circuit
42 Multiplier
43 Accumulator circuit
5 Quantization operation circuit
52 Vector operation circuit
53 Quantization circuit
6 Controller

1. A neural network training device that trains a neural network performing an inference operation in a neural network circuit, the neural network training device comprising:
a training unit configured to generate a trained parameter including a threshold value which is used in a quantization operation using a functional model of the neural network performing a convolutional operation and the quantization operation based on a floating decimal point format,
wherein the training unit generates the threshold value on the basis of a difference between an operation environment of the neural network circuit and an operation environment of the functional model.

2. The neural network training device according to claim 1, wherein the neural network circuit performs a convolutional operation and a quantization operation based on an integer format, and
wherein the training unit generates the threshold value which is not included in a forbidden band in which an error from an interger value is less than an allowable error.

3. The neural network training device according to claim 2, wherein the training unit re-performs training and generates a new threshold value when the generated threshold value is included in the forbidden band.

4. The neural network training device according to claim 2, wherein the allowable error is a value which is infinitely close to zero.

5. The neural network training device according to claim 1, further comprising a functional model generating unit configured to generate the functional model including convertible operation blocks that are able to be converted to arithmetic operations that are able to be performed in the neural network circuit performing a convolutional operation and a quantization operation based on an integer format.

6. The neural network training device according to claim 5, further comprising a software generating unit configured to convert the convertible operation blocks of the functional model to arithmetic operations that are able to be performed in the neural network circuit and to generate software for causing the neural network circuit to perform the converted arithmetic operation and the trained parameter.

7. The neural network training device according to claim 6, wherein the training unit concentrates at least some arithmetic operations of the convertible operation blocks of the functional model on the threshold value.

8. A neural network training method of training a neural network performing an inference operation in a neural network circuit, the neural network training method comprising:
a training step of generating a trained parameter including a threshold value which is used in a quantization operation using a functional model of the neural network performing a convolutional operation and the quantization operation based on a floating decimal point format,
wherein the training step includes generating the threshold value on the basis of a difference between an operation environment of the neural network circuit and an operation environment of the functional model.

9. The neural network training method according to claim 8, wherein the neural network circuit performs a convolutional operation and a quantization operation based on an integer format, and
wherein the training step includes generating the threshold value which is not included in a forbidden band in which an error from an integer value is less than an allowable error.

10. The neural network training method according to claim 9, wherein the training step includes re-performing training and generating a new threshold value when the generated threshold value is included in the forbidden band.

11. The neural network training method according to claim 9, wherein the allowable error is a value which is infinitely close to zero.

12. The neural network training method according to claim 8, further comprising a functional model generating step of generating the functional model including convertible operation blocks that are able to be converted to arithmetic operations that are able to be performed in the neural network circuit performing a convolutional operation and a quantization operation based on an integer format.

13. The neural network training method according to claim 12, further comprising a software generating step of converting the convertible operation blocks of the functional model to arithmetic operations that are able to be performed in the neural network circuit and generating software for causing the neural network circuit to perform the converted arithmetic operation and the trained parameter.

14. The neural network training method according to claim 13, wherein the training step includes concentrating at least some arithmetic operations of the convertible operation blocks of the functional model on the threshold value.
